(19) United States
(12) Patent Application Publication
(10) Pub. No.: US 2018/0250998 A1
(43) Pub. Date: Sep. 6, 2018

(54) Wheel Module with Integrated Active Suspension

(71) Applicant: Axel Michael Sigmar, Lago Vista, TX (US)

(72) Inventor: Axel Michael Sigmar, Lago Vista, TX (US)

(21) Appl. No.: 15/859,489

(22) Filed: Dec. 30, 2017

Related U.S. Application Data
(60) Provisional application No. 62/440,984, filed on Dec. 30, 2016.

(51) Int. Cl. B60G 17/015; B60G 17/02; B60G 15/02; B60G 17/019; B60G 17/06

(52) U.S. Cl. CPC B60G 17/0152; B60G 17/021; B60G 15/02; B60G 3/207; B60G 17/06; B60G 2200/144; B60G 17/019

(57) ABSTRACT

In some embodiments, an apparatus may include a wheel module including a linear actuator, a piston, a drive element, and a coil. The linear actuator may include a stator and a piston configured to fit within the stator. The piston includes a plurality of permanent magnets responsive to coils of the stator to move relative to the stator. The apparatus further includes a drive element threadably coupled to an external surface of the linear actuator. The drive element includes a plurality of permanent magnets responsive to the coils of the stator to move relative to the stator. The apparatus also includes a coil configured to fit over the linear actuator.

### CROSS-REFERENCE TO RELATED APPLICATION(S)

This application is a non-provisional of and claims priority to U.S. Provisional Patent Application No. 62/440,984 filed on Dec. 30, 2016 and entitled “Active Series Hybrid Integrated Electric Vehicle”, which is incorporated herein by reference in its entirety.

### FIELD

The present disclosure is generally related to vehicles that include at least three wheels, and more particularly to a vehicle including a plurality of wheels where each wheel includes an integrated active suspension feature configured to dynamically adjust the damping provided by the suspension.

### BACKGROUND

Industrial vehicles and passenger vehicles typically include an engine, a transmission coupling the engine to driving wheels, and a pair of steerable wheels. The steerable wheels may be controlled by a steering wheel or other steering device provided adjacent to a driver's seat. I;1,.

n many cars and trucks, the steering mechanisms may be aided by power steering mechanisms to assist the driver in turning the wheels.

In general, the vehicle suspension includes a combination of the tires, the tire air pressure, springs, and linkages that couple the frame of a vehicle to the wheels. Generally, the vehicle suspension allows for relative motion between the vehicle frame and its wheels to support both handling and ride safety. In particular, the vehicle suspension is responsible for maintaining contact between the wheel and the road surface. Further, the suspension is responsible for damping of impacts and vibrations to limit damage and wear due to bumps and other sources of vibrations.

The spring rate is a parameter that is used to establish a vehicle's ride height relative to the travel distance of the suspension spring or stroke. When a spring is compressed or stretched, the force it exerts is proportional to its change in length. Vehicles that carry heavy loads may have heavier springs to compensate for the additional load weights, which might otherwise cause the vehicle to ride at the bottom of its spring compression or stroke.

Springs that are too hard or too soft may cause the suspension to be ineffective because they do not provide damping or isolation from such impacts or vibrations. For example, vehicles that commonly experience heavy loads (such as long haul trucks) may have heavy or hard springs with a spring rate that is close to an upper weight limit for the vehicle's loads, allowing the vehicle to perform properly under a heavy load. Unfortunately, when the vehicle's load is reduced or emptied, the vehicle's ride may be relatively unsafe for passengers because of its high spring rate. Softer springs may allow the weight of the vehicle to cause the suspension to ride lower to the ground, reducing the overall amount of compression available to the suspension.

### SUMMARY

In some embodiments, an apparatus may include a wheel module including a linear actuator, a piston, a drive element, and a coil. The linear actuator may include a stator and a piston configured to fit within the stator. The piston includes a plurality of permanent magnets responsive to coils of the stator to move relative to the stator. The apparatus further includes a drive element threadably coupled to an external surface of the linear actuator. The drive element includes a plurality of permanent magnets responsive to the coils of the stator to move relative to the stator. The apparatus also includes a coil configured to fit over the linear actuator.

In other embodiments, a system may include a control circuit, a frame of a vehicle, and at least one wheel module coupled to the frame of the vehicle. The wheel module may include a wheel and at least one suspension spring assembly including an actuator responsive to a signal from the control circuit to selectively adjust at least one of a compression stroke and a spring compression parameter of the wheel during operation.

In still other embodiments, a method of providing an active suspension may include receiving signals from a plurality of sensors at a control circuit and determining a plurality of active suspension adjustments based on the received signals for each of a plurality of wheel modules. The method may further include selectively adjusting an active suspension parameter for each of the plurality of wheel modules by sending one or more control signals to an active suspension assembly of each of the wheel modules.

### BRIEF DESCRIPTION OF THE DRAWINGS

FIG. 1 depicts a perspective view of a vehicle including a plurality of wheel modules with integrated active suspension features, in accordance with certain embodiments of the present disclosure.

FIG. 2 depicts a block diagram of a system configured to provide dynamic active suspension features, in accordance with certain embodiments of the present disclosure.

FIG. 3 depicts an exploded perspective view of structural components configured to provide an integrated active suspension, in accordance with certain embodiments of the present disclosure.

FIG. 4 depicts a perspective view of an apparatus including coil having adjustable compression, in accordance with certain embodiments of the present disclosure.

FIG. 5A-5C depict views of a linear actuator portion of the apparatus of FIG. 4, in accordance with certain embodiments of the present disclosure.

FIG. 5D depicts a perspective view of a drive element portion of the apparatus of FIG. 4, in accordance with certain embodiments of the present disclosure.

FIGS. 6A and 6B depict views of the drive element portion of the apparatus of FIGS. 4 and 5D, in accordance with certain embodiments of the present disclosure.

FIG. 7A depicts a side view of the apparatus of FIG. 4, in accordance with certain embodiments of the present disclosure.

FIG. 7B depicts a side cross-sectional view of the apparatus of FIG. 7A.

FIG. 8 depicts a front perspective view of a portion of a vehicle including wheel modules configured to provide independent, integrated active suspension, in accordance with certain embodiments of the present disclosure.

FIG. 9 depicts a method of adjusting compression of a vehicle's suspension, in accordance with certain embodiments of the present disclosure.

FIG. 10 depicts a method of adjusting compression of a vehicle's suspension to raise a wheel above the road surface, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Embodiments of systems, methods, and devices are described below that can be configured to provide independent active suspension adjustments, dynamically. In general, spring travel or compression travel refers to a measure of a distance from a bottom of a suspension stroke (such as when the vehicle is raised on a jack and the wheel is hanging freely) to a top of the suspension stroke (when the vehicle's wheel can no longer travel in an upward direction). Too much weight or worn springs can cause the spring to compress too much, causing the wheel to “bottom out” against an underside of a vehicle, which can cause vehicle control problems or damage to the vehicle or the wheels. Conventionally, most vehicles utilize passive springs to absorb impacts and dampers or shock absorbers to control spring motions.

Embodiments of systems, methods, and apparatuses are described below that may be integrated within a wheel module to provide a dynamically adjustable compression to produce an active suspension. The apparatus may include a linear actuator including an electromagnetic drive motor configured to drive an extendable piston. The apparatus may further include a compressible spring extending over the linear actuator, and a rotatable electromagnetic structure configured to engage threads on an external surface of the electromagnetic motor drive and configured to advance along a length of the linear actuator to compress the spring.

Embodiments of the systems, methods, and apparatuses provide dynamic adjustment of the suspension of a vehicle for each of a plurality of wheel modules, independently. The dynamic adjustments can be used to manage load distribution, improve vehicle handling, and enhance ride safety. Moreover, the dynamic adjustments can be used to raise a wheel above the ground dynamically, such as when tire pressure is low or when the tire is damaged or flat, and to redistribute the load across multiple other wheel modules so that the vehicle can continue to travel. Other embodiments are also possible.

Embodiments of systems, methods, and devices may include a mounting frame and a pair of adjustable spring devices coupled between the mounting frame and a frame of a vehicle. Each of the adjustable spring apparatuses includes a linear actuator having an extendable piston, a rotatable or drive element configured to rotationally advance along a length of the linear actuator to provide a stop; and a spring configured to fit over the linear actuator and to rest on the stop. The rotatable element may be rotated to move along threads on an external surface of the linear actuator to apply and maintain a compressive force on the spring. The piston of the linear actuator may provide a second stop for the spring. The piston may be extended to further adjust the compression applied to the spring. By adjusting the position of the rotatable element and the extension of the piston of the linear actuator, the suspension stroke may be adjusted and the compression on the spring may also be adjusted, providing an active suspension.

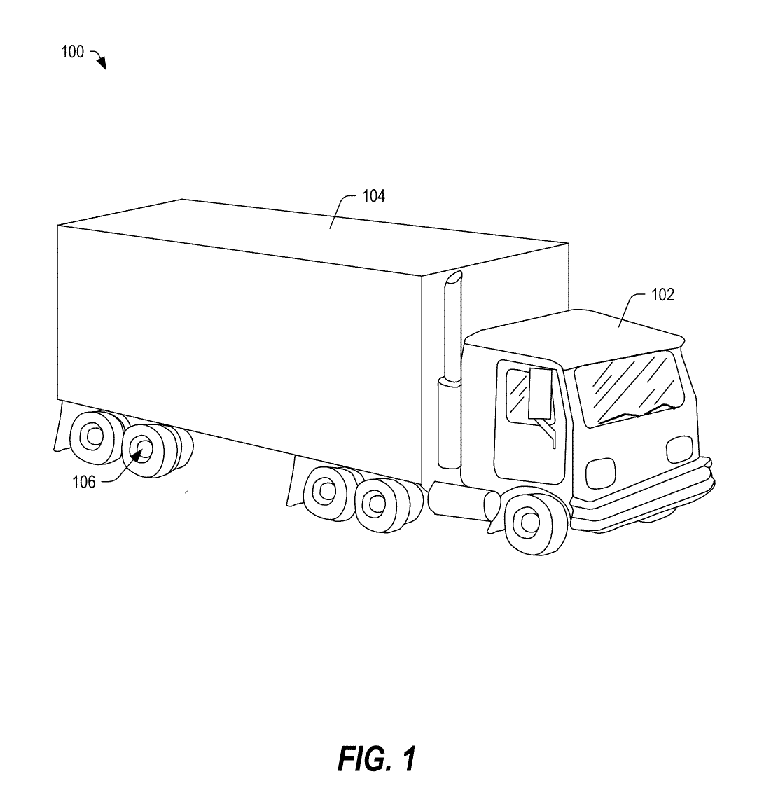

FIG. 1 depicts a perspective view of a vehicle 100 including a plurality of wheel modules 106, each of which includes an integrated active suspension, in accordance with certain embodiments of the present disclosure. The vehicle 100 may include a cab 102 and a trailer 104 including a plurality of wheel modules 106. Each wheel module 106 may include one or more tires and a driven active suspension or coil assembly. Each integrated wheel module 106 may include a driven active suspension (coil assembly) including a coil and a linear dampening motor configured to define a first stop for the coil (or spring) and including a rotational motor configured to define a second stop for the coil to provide a desired compression.

In some embodiments, a control circuit may be configured to provide control signals to the driven active suspension to control a linear motor of a coil assembly to selectively adjust a spring rate and dampening effect of the coils. In some examples, the linear motor of the coil assembly may be used to dynamically compress the coil in a positive or negative direction. Further, in some examples, the linear motor of the coil assembly may dynamically adjust a load on a coil by adjusting a linear motor relative to the coil to enhance the operation of the shock absorption, to balance a load, to assist in off-setting centrifugal forces during a turn, for other reasons, or any combination thereof. In certain embodiments, by adjusting the linear motor, the integrated wheel module 106 may be raised or lowered relative to the frame of the vehicle.

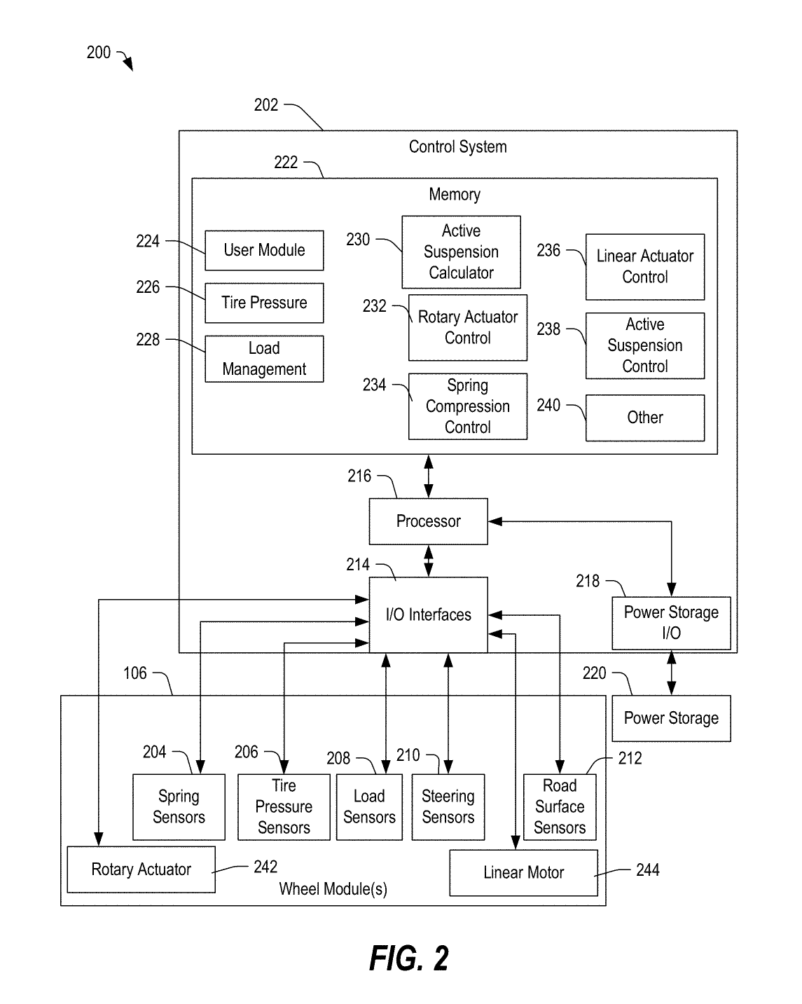

FIG. 2 depicts a block diagram of a system 200 configured to provide an active suspension, in accordance with certain embodiments of the present disclosure. The system 200 may include a control system 202 coupled to a plurality of sensors associated with each of the wheel modules 106. The sensors may include spring sensors 204, tire pressure sensors 206, load sensors 208, steering sensors 210, and road surface sensors 212. Each sensor 204, 206, 208, 210, and 212 may provide a signal proportional to a sensed parameter to the control system 202.

The control system 202 may include one or more input/output (I/O) interfaces 214. The I/O interfaces 214 may be coupled to or otherwise configured to receive signals from the sensors 204, 206, 208, 210, and 212. The I/O interfaces 214 may be coupled to a processor 216, which may be coupled to power storage 220 (such as a plurality of batteries) via a power storage I/O interface 218. The processor 216 may also be coupled to a memory 222, which may be configured to store processor-executable instructions as well as data.

The memory 222 may include a graphical user interface (GUI) module 224 that, when executed, can cause the processor 216 to provide a graphical interface through which a user may interact with the control system 202. In some embodiments, the I/O interfaces 214 may be coupled to a touchscreen interface or other input device to view and configure the active suspension settings of the system 200.

The memory 222 may also include a tire pressure module 226 that, when executed, may cause the processor 216 to determine the tire pressure associated with the one or more tires of the wheel module 106. The memory 222 may further include a load management module 228 that, when executed, may cause the processor 216 to determine loads borne by each of the wheel modules 106 and to determine load balancing adjustments for the active suspension components based on the distribution of the loads across multiple wheel modules 106.

The memory 222 may further include an active suspension module 230 that, when executed, may cause the processor 216 to determine active suspension adjustments for each of the plurality of wheel modules 106. The memory 222 further includes a rotary actuator control module 232 that, when executed, may cause the processor 216 to determine a rotary actuator adjustment based on the active suspension adjustments. The memory 222 may also include a spring compression control module 234 that, when executed, may cause the processor 216 to determine compression on the spring or coil based on sensor data from the spring sensors 204. The memory 222 may also include a linear actuator control module 236 that, when executed, may cause the processor 216 to control the linear actuator of the active suspension.

The memory 222 can also include an active suspension control module 238 that, when executed, may cause the processor 216 to send control signals to a rotary actuator 242 of the wheel module 106 and to a linear motor 244 of the wheel module 106 based on information determined from the active suspension calculator 230, the rotary actuator control module 232, the spring compression control module 234, and the linear actuator control module 236.

The memory 222 may further include other modules 240 that can be executed by the processor 216 to perform a plurality of other functions. The other modules 240 may cause the processor 216 to control operation of the vehicle, to control operation of one or more actuators (such as gate lift actuators, compression actuators, and the like). Further, in the context of an electrical vehicle, the other modules 240 may include battery status modules, active suspension control modules, motor control modules, other modules, or any combination thereof

In a particular example, the control system 202 may monitor the balance of a load in the trailer 104 as applied to each of the wheel modules 106 and may selectively adjust the active suspension of one or more of the wheel modules 106 to balance the load. In some embodiments, the control system 202 may determine a suitable damping parameter and may adjust the compression applied to the coil to achieve the selected damping. Further, the control system 202 may determine a compression stroke based on a load. The compression stroke may be adjusted by extending the piston of the linear motor 244 and by adjusting the stop position of the rotary actuator 242 to provide a selected compression. Other embodiments are also possible.

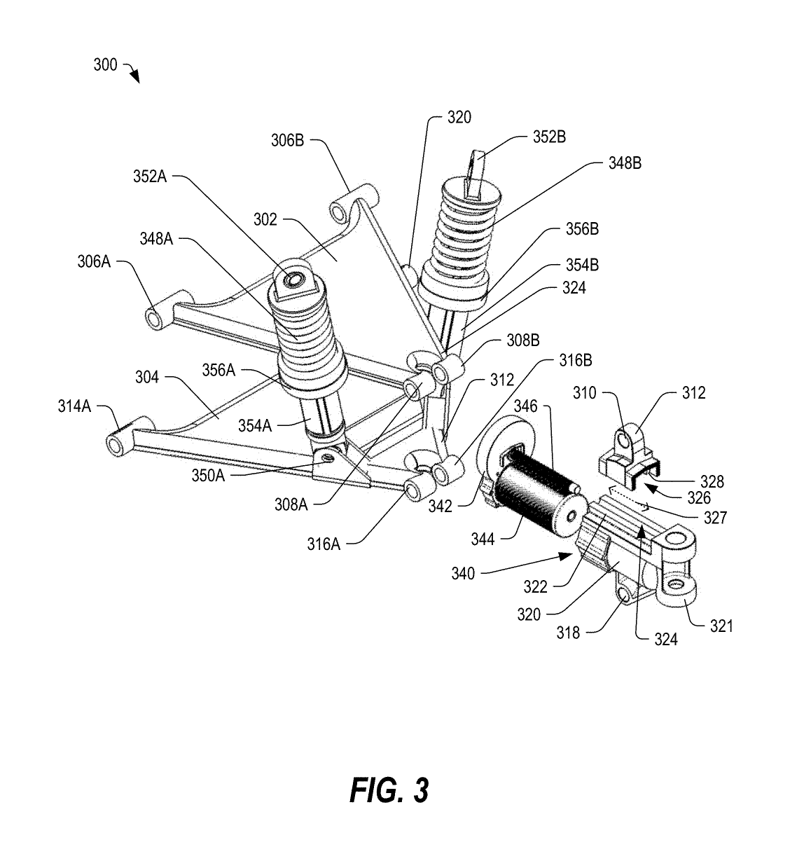

FIG. 3 depicts an exploded perspective view of structural components 300 configured to provide an active suspension, in accordance with certain embodiments of the present disclosure. The structural components 300 may include an upper mounting frame 302 and a lower mounting frame 304. The upper mounting frame 302 includes frame attachment elements 306A and 306B, which may be cylindrical structures sized to receive fasteners (such as a bolts) to couple the frame attachment elements 306A and 306B to corresponding features on the frame of the vehicle. The upper mounting frame 302 further includes slider attachment elements 308A and 308B, which may be cylindrical structures sized to receive a fastener (such as a bolt) to couple to a slider 312.

The lower mounting frame 304 includes frame attachment elements 314A and a corresponding element that is obscured from view by the upper mounting frame 302. The frame attachment element 314A and its corresponding element on the obscured edge of the lower mounting frame 304 may include cylindrical structures sized to receive fasteners (such as bolts) to couple the frame attachment elements 314 to the frame of the vehicle. The lower mounting frame 304 further includes camber housing attachment elements 316A and 316B, which may be cylindrical structures sized to receive a fastener (such as a bolt) to couple the camber housing attachment elements 316A and 316B to a corresponding receptacle 318 of a camber housing 320.

The camber housing 320 may include a guide element 322 including a central groove 324 forming tracks along an upper surface of the camber housing 320. The guide element 322 may be sized to receive a corresponding recess 326 of the slider 312. The recess 326 includes side walls spaced apart to fit over the guide element 322 of the camber housing 320. The recess 326 may include a ridge or extension 328 within the recess 326 to engage the central groove 324. The slider 312 may be configured to slide back and forth along the guide element 322 as indicated by the phantom arrow 327.

The camber housing 320 may define an enclosure 340 sized to receive a portion of an actuator 342, which may include a worm drive having a rotatable gear 344 configured to engage corresponding threads of an articulating shaft 346 configured to move the slider 312 along the guide element 322. The actuator 342 may be an embodiment of the actuator 242 in FIG. 2. The camber housing 320 may further include a coupling 321 configured to receive a king pin or other fastener to secure a steering knuckle or other structure to the camber housing 320. In some embodiments, a wheel including a rim and a tire may be coupled to the steering knuckle. In a particular example, the actuator 324 may be controlled to adjust the position of the slider 312 relative to the housing 320 to adjust the camber angle of the wheel.

The structural components 300 may further include suspension spring assemblies 348A and 348B. The suspension spring assembly 348A may be coupled at a proximal end to a spring attachment element 350A of the lower mounting structure 304 via a fastener, such as a bolt. The distal end of the suspension spring assembly 348A may include a frame attachment element 352A configured to couple to a corresponding attachment feature of the frame of the vehicle. Similarly, the suspension spring assembly 348B may be coupled between a spring attachment element 350B (which is obscured by the upper mounting frame 302) and a frame attachment element 352B, which may be coupled to the frame of the vehicle.

In the illustrated example, the suspension spring assembly 348 may include a linear actuator 354 with a piston that includes the frame attachment element 352. The linear actuator 354 of the suspension spring assembly 348 may include an attachment feature at the proximal end for coupling to the spring attachment element 350A. Further, the linear actuator 354 of the suspension spring assembly 348 may include a drive element 356, which may be configured to advance along the length of the linear actuator 354 by rotating about its external (threaded) surface. The drive element 356 may be coupled to or may include a coil stop, which may cooperate with a coil stop of the piston to apply a selected compression to the coil

It should be understood that the structural components 300 may be included with each of the wheel modules of the vehicle, making it possible to dynamically adjust the active suspension of each wheel module independent from every other wheel module 106. Thus, each wheel can have an independently adjustable active suspension to maintain a desired compression stroke and damping based on the conditions. Further, it should be appreciated that the active suspension adjustments may be implemented dynamically as the vehicle is in motion.

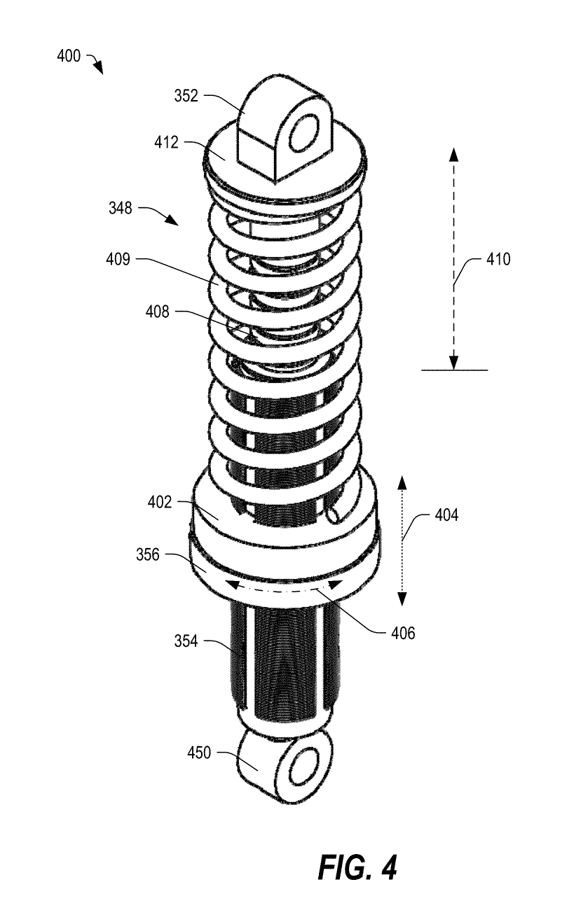

FIG. 4 depicts a perspective view of an apparatus 400 including an active suspension assembly 348 having adjustable compression, in accordance with certain embodiments of the present disclosure. The active suspension assembly 348 may include the linear actuator 354 with an extendable piston 408, which may extend or retract in a direction indicated by arrow 410. The linear actuator 354 may include an attachment feature 450 configured to couple to a spring attachment element 350 of a lower mounting frame 304. Further, the extendable piston 408 may include the frame attachment element 352 and a coil stop 412.

The active suspension assembly 348 may further include the drive element 356 configured to engage threads on an exterior surface of the linear actuator 354. The drive element 356 may be configured to rotate about the exterior surface of the linear actuator 354 as indicated by the arrow 406 to advance along a longitudinal axis of the linear actuator 354 as indicated by the arrow 404. In some embodiments, the drive element 356 may be coupled to or may include a coil stop 402.

In some embodiments, the coil stop 412 and the coil stop 402 may cooperate to apply compression to the spring or coil 409. In an example, extension or retraction of the plunger or piston 408 and rotation of the drive element 356 may cooperate to adjust the compression applied to the spring or coil 409. Other embodiments are also possible.

It should be appreciated that significant additional advantages can be achieved by combining an active camber adjustment with the active suspension. In an example, during cornering, when a load shifts, when the wind is impacting the vehicle path, and so on, the active suspension can be configured to lower one or more wheel modules and to raise one or more wheel modules dynamically and continuously to counteract the changing conditions. Such changes may impact the road contact patch of each tire, and an active camber adjustment may be continuously and dynamically applied in conjunction with the changing suspension in order to maintain a desired contact patch between each tire and the road surface. An example of such a dynamic camber system is described in a co-pending U.S. application Ser. No. ______ filed on Dec. 30, 2017 and entitled “Active Camber Adjustment”. Similarly, incorporation of motor components, active steering, power storage, and other features into the integrated wheel module may achieve further advantages.

In one embodiment, by adjusting the position of the drive element 356 relative to the linear motor 354, the spring compression can be adjusted to find a “neutral point” for any given load and for each wheel module, independently, so that the electromagnetic spring that is in parallel with the coil 409 does not have to expend energy to hold the load continuously. Further, the piston 408 and the linear actuator 354 cooperate to provide an electromagnetic actuator that can act as a virtual spring in parallel with the coil 409 and with a spring rate and damping that is determined by software and configured by the control system 202 in FIG. 2.

In some implementations, the electromagnetic actuator can actively mitigate variations in road surface (bumps, potholes, etc., detected from signals of various sensors within the wheel module or in other wheel modules of the system) in the context of active suspension. In an example, when a wheel module encounters a variation in the road surface, the active suspension of a next wheel module in the direction of travel may adjust the height of the tire, the spring compression, or both in order to reduce the effect of the variation in the road surface. In a particular example, a first wheel module may hit a bump and each subsequent wheel module may skip or step over the bump, reducing vibrations overall and improving the safety of the vehicle.

In the context of the vehicle, the vehicle attitude can be managed for conditions like turns, tilt of the road surface, yaw and pitch of the vehicle, and the control system of the vehicle (or the power electronics of each individual wheel module) can control the active suspension by anticipating adjustments to be made based on signals from yaw rate sensors compared to the steering input. For example, the active suspension may lower the wheel modules on one side and raise wheel modules on the other side of a vehicle to lean the vehicle into a turn. If each wheel module also includes an active camber adjustment feature, the wheel module may also adjust the camber angle of the tires independently to maintain a consistent contact patch with the road surface during the turning operation. The active camber system and the active suspension system may continuously and dynamically adjust the camber angle and the suspension parameters, respectively, returning the wheel modules to a previous state when the operation is completed.

It should be appreciated that, to fully utilize these capabilities and to maximize grip, vehicle dynamics, performance, safety and efficiency, a vehicle may utilize the active camber adjustment as well as the steerable, driven (and rapid electronic braking of an integrated wheel module that includes the motor and associated control electronics. In combination, these features alter the fundamental characteristics of heavy vehicles on the roads.

The active suspension described herein also allows for additional features for tire maintenance, long-haul travel, and so on. In one example, the active suspension can be used to raise the tire off the ground to allow for tire changes without a jack. In another example, the active suspension can independently and selectively raise and lower wheel modules for load leveling on tilted roads or to align with loading docks. The active suspension can operate to change vehicle ground clearance, to step over large obstacles during travel without excessive tipping of the vehicle, which might otherwise cause the vehicle to tip over. In another embodiment, in response to a flat tire, the active suspension may raise the flat tire off of the road, dynamically adjust the suspension parameters of others of the plurality of wheel modules, and allow the operator to continue traveling. Other advantages are also possible.

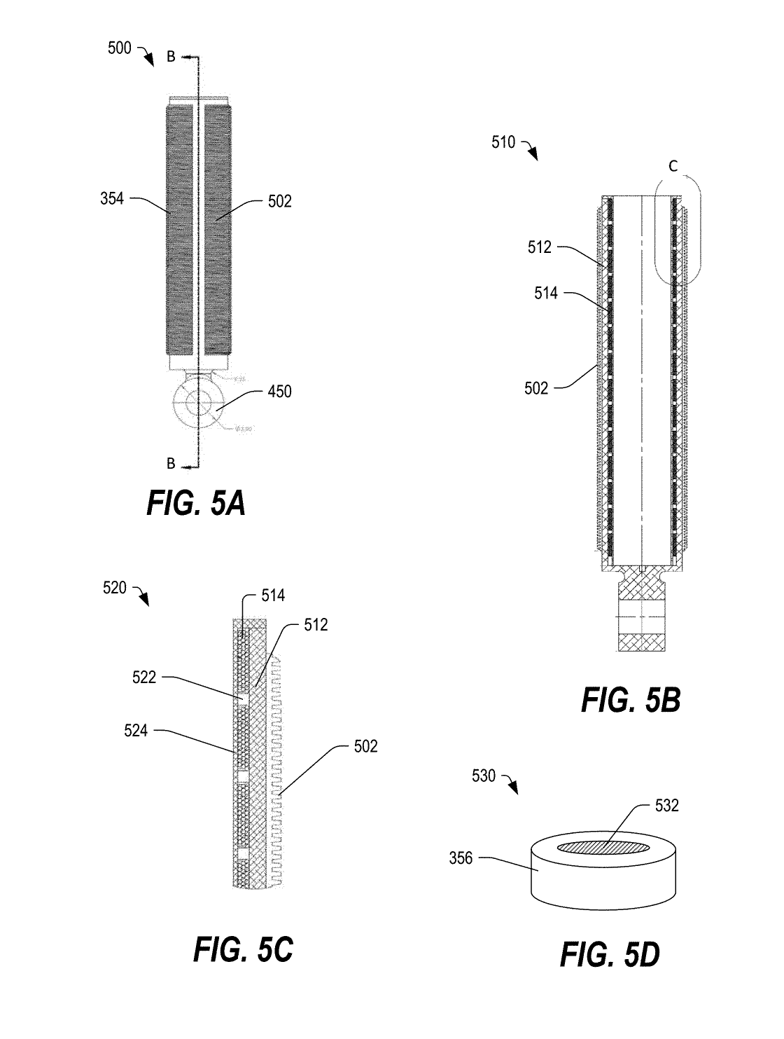

FIGS. 5A-5C depict views of a linear actuator portion of the apparatus of FIG. 4, in accordance with certain embodiments of the present disclosure. In FIG. 5A, the linear actuator 354 includes a stator with a plurality of threads 502 on an exterior surface to engage corresponding teeth or threads on an interior surface of a drive element 356.

FIG. 5B depicts a cross-sectional view 510 of the integrated linear damping stator (the linear actuator 354) taken along line B-B in FIG. 5A. The stator 354 can include a housing including an exterior surface having threads 502 configured to engage corresponding threads of the drive element 356. Further, the stator 354 can include an insulative layer 514 between the exterior surface including the threads 502 and a plurality of electrical coils 512.

FIG. 5C depicts a cross-sectional view 520 of a portion of the integrated linear damping stator 354 taken along line C-C in FIG. 5B. The stator coils 512 may be separated or segmented by an air gap 522. It should be appreciated that the implementation depicted in FIGS. 5A-5C represents one possible example of a housing for the stator 354. Other embodiments are also possible.

FIG. 5D depicts a perspective view 530 of a drive element 356 of the apparatus of FIG. 4, in accordance with certain embodiments of the present disclosure. The drive element 356 may include a central opening sized to fit over the linear actuator or stator 354 and including threads 532 configured to mate with threads 502 on an exterior surface of the linear actuator or stator 354.

It should be appreciated that the drive element 356 can be moved along the threads 502 of the linear actuator or stator 354 to achieve a desired compression of the coil 409. Once the compression is achieved, the linear actuator or stator 354 may be turned off and the load may be maintained by the coil 409, allowing for passive load handling, such as when the vehicle is parked. Other embodiments are also possible.

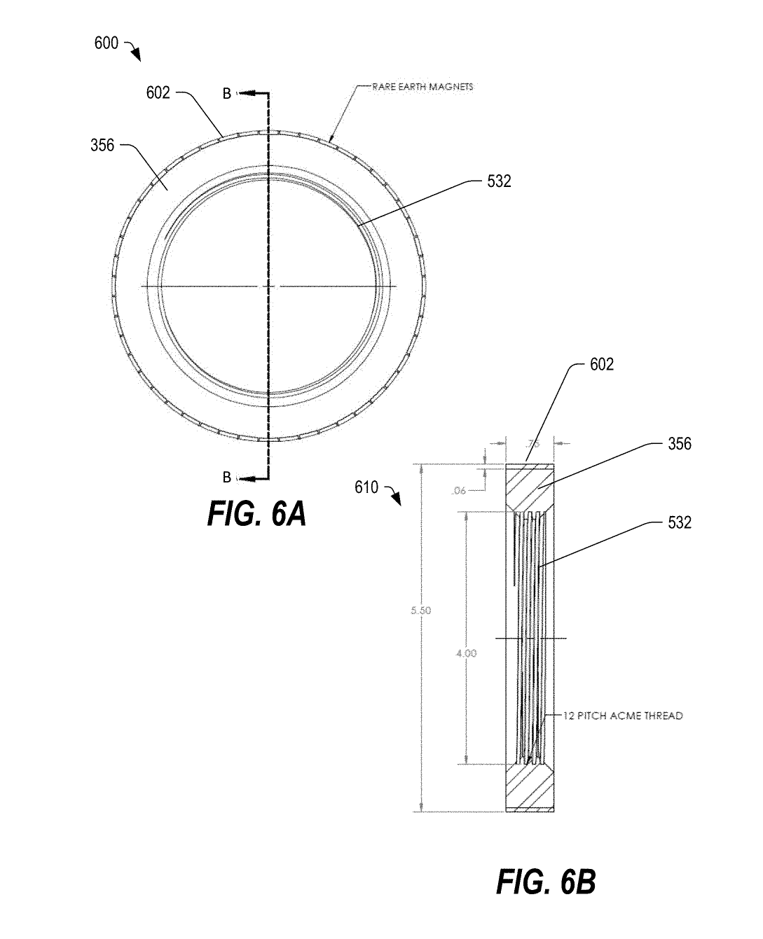

FIGS. 6A and 6B depict views of the drive element portion of the apparatus of FIGS. 4 and 5D, in accordance with certain embodiments of the present disclosure. FIG. 6A depicts a top view 600 of a drive element 356 of an active coil assembly, in accordance with certain embodiments of the present disclosure. The drive element 356 includes a circumferential ring of rare earth magnets 602, which may respond to an electrical field in the coils of the linear actuator or stator 354 in FIG. 5A. Further, the drive element 356 includes threads 532 configured to mate with corresponding threads 502 (FIGS. 5A-5C) on an exterior surface of the linear actuator or stator 354.

FIG. 6B depicts a cross-sectional view of the drive element 356 taken along line B-B in FIG. 6A, in accordance with certain embodiments of the present disclosure. In this example, the threads 532 on an interior surface of the drive element 356 may be configured to engage corresponding threads of the linear actuator or stator 354. The threads 532 may include a 12 pitch thread. Other thread configurations are also possible.

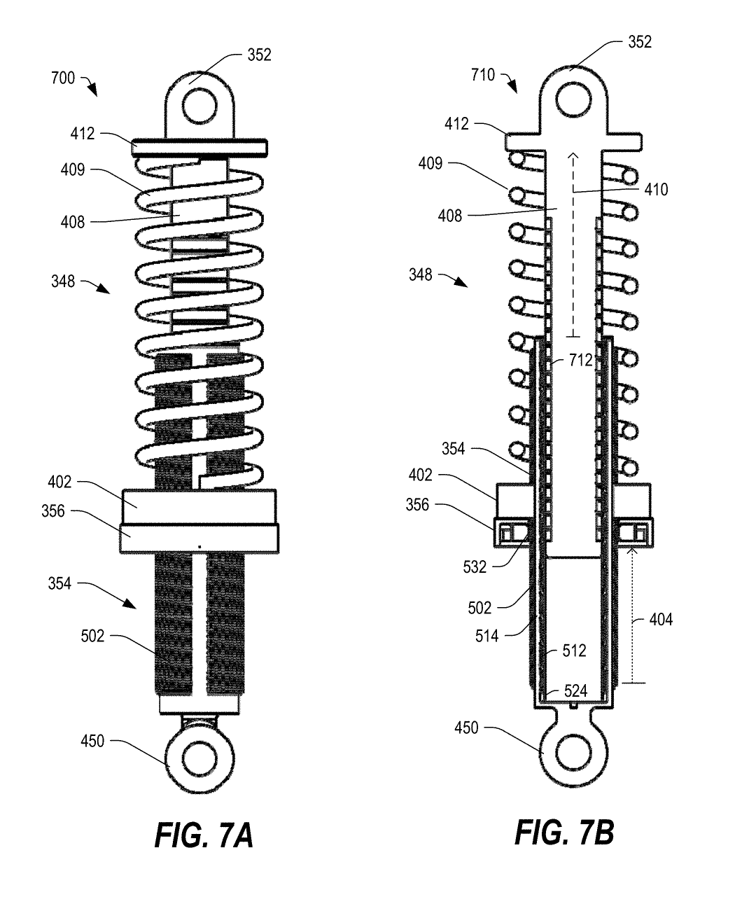

FIG. 7A depicts a side view 700 of the active coil assembly 348 of FIG. 4, in accordance with certain embodiments of the present disclosure. The linear actuator or stator 354 may be configured to drive the piston 408 to extend or retract. Further, the linear actuator or stator 354 may cause the drive element 356 to advance by rotating and advancing along the threads 502). By selectively controlling one or both of the piston 408 and the drive element 356, the compression on the spring 409 can be adjusted.

FIG. 7B depicts a side cross-sectional view 710 of the apparatus of FIG. 7A. The linear actuator 354 includes a plurality of electric coils 512, which may interact with permanent magnets 712 within the piston 408 to extend or retract the piston 408. Further, the linear actuator 354 may induce electrical fields that can interact with the permanent magnets of the drive element 356 to turn the drive element 356, advancing the coil stop 402 to a selected position along the length of the linear actuator 354 as indicated by arrow 404.

In operation, the plunger or piston 408 may be extended and the drive element 356 lowered to reduce the compression on the spring or coil 409 and increasing the stroke of the compression. The plunger or piston 408 may be retracted, the drive element 356 may be raised, or both, to increase the compression on the coil or spring 409. In each instance, the linear actuator or stator 354 may be responsive to control signals from a circuit to provide an active suspension. Other embodiments are also possible.

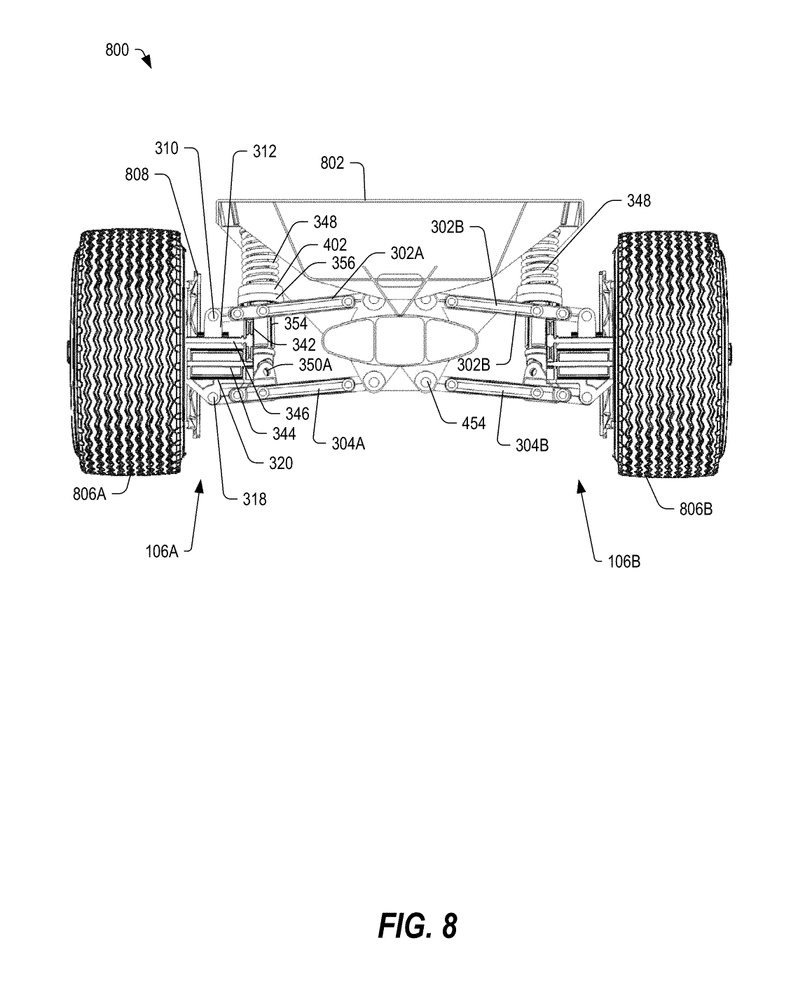

FIG. 8 depicts a front perspective view of a portion of a vehicle 800 including wheel modules 106 configured to provide independent, integrated active suspension, in accordance with certain embodiments of the present disclosure. The vehicle 800 may include a frame 802 coupled to wheel modules 106A and 106B, each of which includes the structural components 300 of FIG. 3, a respective tire 806A and 806B, and a steering knuckle 808 connected to the coupling 321 of FIG. 3.

In the illustrated example, by controlling the actuator 342, the rotatable gear 344 may be configured to engage corresponding threads of the articulating shaft 346 to move the camber housing 320 relative to the tire 406 and the frame 402. The slider 312 may move along the guide 322 (shown in FIG. 3) while the receptacle 318 of the camber housing 320 remains rigidly coupled to the lower mounting frame 304A. The bolt extending through the receptacle 318 and the camber housing attachment elements 316 of the lower mounting frame 304 provides a pivot point about which the camber housing 320 may rotate, allowing the tire 410 to tilt to adjust the camber angle of the tire 406.

Further, the active suspension assembly 348 may be coupled between the lower frame 304 and the frame 802 of the vehicle 800. As discussed above, the active suspension assembly 348 may include a linear actuator or stator 354 with an extendable piston or plunger 408 (shown in FIGS. 4, 7A and 7B. Further, the active suspension assembly 348 includes the drive element 356 and the coil stop 402 configured to advance toward the frame 802 to compress the spring or coil 409 and to move away from the frame 802 to reduce the compression on the spring or coil 409.

In some embodiments, a control system or control circuit (such as the system 200 in FIG. 2) may be housed within an enclosed portion of the frame 802 of the vehicle 800 and may be coupled to the active suspension assembly 348 and to a plurality of sensors (not shown) via wired connections. In some examples, the control circuit or control system 200 may determine various parameters of the tire, the road pitch, the road conditions, the steering control signals, and the load and may selectively adjust the active suspension of the wheel modules 106A and 106B.

It should be appreciated that the coil compression adjustments provided by the active suspension assembly 348 may be configured to be different for each of the wheel modules 106. In one possible example, the active suspension assembly 348 may be adjusted to raise a tire above the surface of the road. In some embodiments, the control system or circuit 200 may selectively control the timing of the coil compression adjustment for each wheel module 106. Other embodiments are also possible.

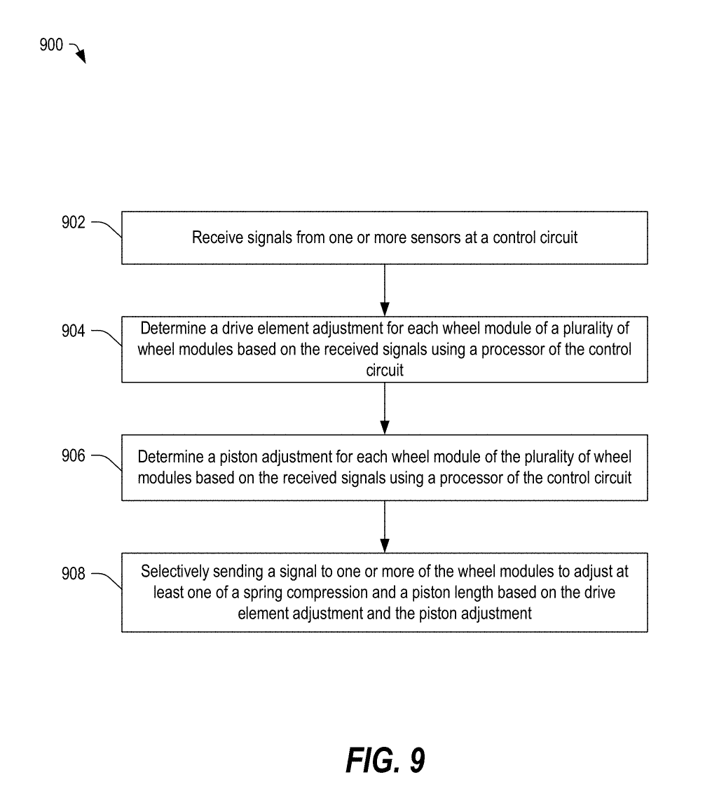

FIG. 9 depicts a method 900 of adjusting compression of a vehicle's suspension, in accordance with certain embodiments of the present disclosure. At 902, the method 900 may include receiving signals from one or more sensors at a control circuit. The sensors may include load sensors, spring sensors, and other sensors.

At 904, the method 900 can include determining a drive element adjustment for each wheel module of a plurality of wheel modules based on the received signals using a processor of the control circuit. In some embodiments, the drive element adjustment for each wheel module 106 may be determined in order to control a position of the drive element along a length of the linear actuator 354. In some embodiments, the drive element of one particular wheel module 106 may be adjusted compress or decompress the spring or coil. Other embodiments are also possible.

At 906, the method 900 may include determining a piston adjustment for each wheel module of the plurality of wheel modules based on the received signals using a processor of the control circuit. The piston adjustment for each wheel module 106 may be determined to control a distance between the frame supporting element 302 and the frame 802 and to extend a distance between the coil stop 402 and the coil stop 412 to adjust a compression of the coil 409.

At 908, the method 900 may include selectively sending a signal to one or more of the wheel modules to adjust at least one of the spring compression and the piston length based on the drive element adjustment and the piston adjustment. In some embodiments, the drive element may be advanced or retracted, the piston may be advanced or retracted, or both. Other embodiments are also possible.

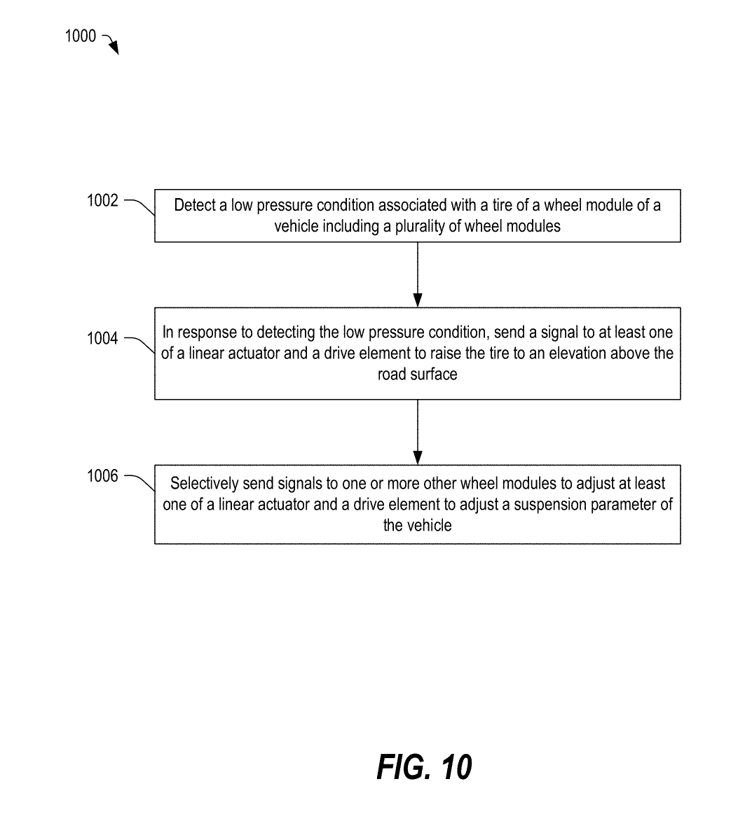

FIG. 10 depicts a method 1000 of adjusting compression of a vehicle's suspension to raise a wheel above the road surface, in accordance with certain embodiments of the present disclosure. At 1002, the method 1000 may include detecting a low pressure condition associated with a tire of a wheel module of a vehicle that includes a plurality of wheel modules. The low pressure condition may include a flat tire.

At 1004, the method 1000 may include sending a signal to at least one of a linear actuator and a drive element to raise the tire to an elevation above the road surface, in response to detecting the low pressure condition. At 1006, the method 1000 can include selectively sending signals to one or more of the other wheel modules to adjust at least one of a linear actuator and a drive element to adjust a suspension parameter of the vehicle.

It should be understood that the flow diagrams of FIGS. 1-10 are provided for illustrative purposes only. Steps may be omitted or combined without departing from the scope of the present disclosure. Further, it should be appreciated that a first active suspension adjustment of a first wheel module and a second active suspension adjustment of a second wheel module may be different. Additionally, the first active suspension adjustment may be applied at a first time, and the second active suspension adjustment may be applied at a second time. Other embodiments are also possible.

In conjunction with the systems, methods, and devices described above with respect to FIGS. 1-10, an apparatus may include an active suspension including a linear actuator with a piston defining a first coil stop, a drive element defining a second stop, and a coil configured to be compressed between the first and second stops. In a particular example, the linear actuator may include a stator configured to engage permanent magnets of the piston to drive the piston toward or away from the frame of the vehicle. Further, the drive element may be configured to rotate about the linear actuator and to engage threads of the linear actuator to move along the length of the linear actuator housing. Other embodiments are also possible.

Although the present invention has been described with reference to preferred embodiments, workers skilled in the art will recognize that changes may be made in form and detail without departing from the scope of the invention.

What is claimed is:

1. An apparatus comprising:
a wheel module including:
a linear actuator including a stator;
a piston configured to fit within the stator and including a plurality of permanent magnets responsive to coils of the stator to move relative to the stator;
a drive element threadably coupled to an external surface of the linear actuator and including a plurality of permanent magnets responsive to the coils of the stator to relative to the stator; and
a coil configured to fit over the linear actuator.

2. The apparatus of claim 1, wherein the piston comprises:
a proximal end within the stator and including the plurality of permanent magnets; and
a distal end including a frame attachment element configured to couple to a frame of a vehicle and including a coil stop.

3. The apparatus of claim 2, wherein:
the drive element defines a second coil stop; and
the drive element and the coil stop of the distal end of the piston cooperate to compress the coil.

4. The apparatus of claim 1, wherein the drive element and the linear actuator cooperate to raise a tire of the wheel module above a road surface in response to a control signal.

5. The apparatus of claim 1, wherein the wheel module further comprises:
a plurality of sensors configured to generate signals in proportion to one or more parameters to be measured; and
a control circuit configured to receive signals from the plurality of sensors and configured to determine an active suspension adjustment in response to receiving the signals.

6. The apparatus of claim 1, wherein:
the linear actuator includes an exterior surface including a plurality of threads; and
the drive element includes an interior surface including a second plurality of threads configured to threadably engage the plurality of threads of the linear actuator.

7. A system comprising:
a control circuit;
a frame of a vehicle;
at least one wheel module coupled to the frame of the vehicle, the at least one wheel module including:
a wheel; and
at least one suspension spring assembly including an actuator responsive to a signal from the control circuit to selectively adjust at least one of a compression stroke and a spring compression parameter of the wheel during operation.

8. The system of claim 7, wherein:
the at least one wheel module includes a plurality of sensors including at least one of a load sensor, a tire pressure sensor, and a steering sensor; and
the control circuit generates the signal to adjust the at least one of the compression stroke and the spring compression parameter in response to a measurement signal from at least one of the plurality of sensors.

9. The system of claim 8, wherein the control circuit is configured to control the at least one wheel module to raise the wheel above a surface of the road.

10. The system of claim 7, wherein the at least one wheel module includes:
a frame structure including a first end configured to couple to the frame of the vehicle and including a second end configured to couple to the wheel through a camber housing;
the at least one suspension spring assembly including a first suspension spring assembly coupled between a first attachment element of the frame structure and the frame of the vehicle and including a second suspension spring assembly coupled between a second attachment element of the frame structure and the frame of the vehicle.

11. The system of claim 7, wherein the actuator includes a stator configured to drive at least one of the piston and the drive element in response to a control signal from a control circuit.

12. The system of claim 7, wherein:
the actuator is responsive to the signal from the control circuit to adjust the compression stroke by causing the actuator to move the piston;
the piston is extended to increase the compression stroke; and
the piston is retracted to decrease the compression stroke.

13. The system of claim 7, wherein:
the actuator is responsive to the signal from the control circuit to adjust the spring compression parameter by causing the actuator to move the drive element;
the drive element is advanced toward the frame of the vehicle to increase the spring compression parameter; and
the drive element is retracted to decrease the spring compression parameter.

14. A method of providing an active suspension, the method comprising:
receiving signals from a plurality of sensors at a control circuit;
determining a plurality of active suspension adjustments based on the received signals for each of a plurality of wheel modules; and
selectively adjusting an active suspension parameter for each of the plurality of wheel modules by sending one or more control signals to an active suspension assembly of each of the wheel modules.

15. The method of claim 14, wherein selectively adjusting the active suspension parameter comprises:
sending a signal to a stator of the active suspension assembly to selectively move a piston of the active suspension assembly of a selected one of the plurality of wheel modules; and
controlling a drive element coupled to a housing of the stator to adjust a compression applied to a coil.

16. The method of claim 14, wherein receiving the signals includes:
receiving a tire pressure signal from a tire pressure sensor of a first wheel module of the plurality of wheel modules, the tire pressure signal indicating a tire pressure that is below a threshold tire pressure; and
in response to determining the tire pressure is below the threshold tire pressure, the method further includes sending a signal to the active suspension assembly of the first wheel module to raise a wheel of the first wheel module above a road surface.

17. The method of claim 14, wherein selectively adjusting an active suspension parameter for a selected one of the plurality of wheel modules comprises:
advancing a piston of a linear actuator of an active suspension assembly toward a frame of a vehicle; and
moving a drive element of the active suspension assembly away from the frame of the vehicle to reduce a compression applied to a coil of the active suspension assembly.

18. The method of claim 14, wherein selectively adjusting an active suspension parameter for a selected one of the plurality of wheel modules comprises:
sending a first control signal to selectively adjust a piston of a linear actuator of the active suspension assembly of a selected one of the plurality of wheel modules relative to a frame of a vehicle; and
sending a second control signal to selectively adjust a drive element of the active suspension assembly of a selected one of the plurality of wheel modules relative to a frame of a vehicle.

19. The method of claim 18, further comprising:
selectively controlling timing of the sending of the first control signal and the sending of the second control signal to the selected one of the plurality of wheel modules; and
selectively controlling timing of sending of a third control signal to a second one of the plurality of wheel modules to provide a first active suspension adjustment of the selected one of the plurality of wheel modules at a first time and to provide a second active suspension adjustment of the second one of the plurality of wheel modules at a second time.

20. The method of claim 19, wherein the first active suspension adjustment is different from the second active suspension adjustment.
